(19) United States
(12) Patent Application Publication
(10) Pub. No.: US 2005/0044428 A1
(43) Pub. Date: Feb. 24, 2005

(54) Means for improving system operation by creating dependency between a power control and a latch

(76) Inventor: Anthony Olson, Dakota Dunes, SD (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/645,678

(22) Filed: Aug. 21, 2003

(51) Int. Cl. G06F 1/26

(52) U.S. Cl. 713/300

(57) ABSTRACT

The present invention is directed to a means for improving system operation by creating a dependency between a power control and a latch. A method for controlling utilization of an external power switch of an information handling system may include detecting an indication from a display closed switch of the information handling system. A transition from a first power state to a second power state as initiated by the external power switch of the information handling system is disabled when the detected indication of the display closed switch indicates that a display of the information handling system is closed.

### FIELD OF THE INVENTION

The present invention generally relates to the field of information handling systems, and particularly to a means for improving system operation by creating dependency between a power control and a latch.

### BACKGROUND OF THE INVENTION

Portable information handling systems may be utilized in a wide variety of locations. Additionally, due to their portable nature, portable information handling systems are often configured to obtain different configurations for transport and utilization of the information handling system to protect the information handling system from damage while being transported, such as in a closed orientation. Further, the information handling system may also be configured for use in an open orientation to enable a user to enter data and interact with the information handling system in an efficient manner.

Because information handling systems may be utilized in a variety of circumstances, the positioning of the functional components may not be as convenient in some situations as in others, and may result in inadvertent implementation of a function of the information handling system. For instance, an external power switch may be positioned to be easily accessible to a user when in an office setting, but may be susceptible to involuntary operation in other settings. Additionally, the susceptibility may be further dependent of which configuration of multiple configurations the information handling system is configured.

Therefore, it would be desirable to protect an information handling system from inadvertent operation of a power switch.

### SUMMARY OF THE INVENTION

Accordingly, the present invention is directed to a means for improving system operation by creating a dependency between a power control and a latch. In an aspect of the present invention, a method for controlling utilization of an external power switch of an information handling system includes detecting an indication from a display closed switch of the information handling system. A transition from a first power state to a second power state as initiated by the external power switch of the information handling system is disabled when the detected indication of the display closed switch indicates that a display of the information handling system is closed.

In an additional aspect of the present invention, an information handling system includes a display portion having a display device and an input portion including an input device for input of data by a user of the information handling system. The input portion is rotatable connected to the display portion so that the information handling system is positionable in at least two orientations, including a closed orientation and an open orientation. The open orientation enables a user to interact with the input device on the input portion. A locking member is disposed on at least one of a display portion of the information handling system and an input portion of the information handling system. A receptacle is disposed on at least one of a display portion of the information handling system and an input portion of the information handling system. An external power switch manipulable by a user in both the open orientation and the closed orientation of the information handling system is also included. Positioning the locking member within the receptacle disables at least one criterion for transition from a first power state to a second power state of the information handling system as initiated by the external power switch of the information handling system.

In a further aspect of the present invention, a method for controlling utilization of an external power switch of an information handling system, the information handling system capable of attaining at least three different orientations for utilization by a user includes detecting an indication from an information handling system of the orientation of the information handling system into one of the at least three orientations. The at least three orientations include an open orientation, a closed orientation and a tablet orientation. A criterion for transition from a first power state to a second power state of the information handling system as initiated by the external power switch of the information handling system is instigated. The criterion is dependent on which orientation the information handling system is positioned of the at least three orientations.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of an exemplary embodiment of the present invention wherein a portable information handling system in an open orientation is shown;

FIG. 2 is an illustration of an exemplary embodiment of the present invention wherein a portable information handling system of FIG. 1 is shown in a closed orientation;

FIG. 3 is a flow diagram depicting an exemplary method of the present invention wherein a detected indication from a display closed switch of an information handling system is utilized to disable a transition between power states as initiated by an external power switch;

FIG. 4 is a flow diagram depicting an exemplary method of the present invention wherein user interaction with an information handling system having multiple configurations is shown;

FIG. 5 is a flow diagram of an exemplary method of the present invention wherein a criterion for operation of a power switch of an information handling system is dependent on the orientation of the information handling system;

FIGS. 6A & 6B are illustrations of an exemplary embodiment of the present invention wherein an information handling system capable of attaining a tablet orientation is shown;

FIG. 7 is a flow diagram of an exemplary method of the present invention wherein user interaction with an information handling system capable of attaining at least three orientations is shown; and

FIG. 8 is a flow diagram depicting an exemplary method of the present invention wherein criterion are instigated for operation of an external power switch depending on which orientation of at least three orientations an information handling system is configured.

### DETAILED DESCRIPTION OF THE INVENTION

Reference will now be made in detail to the presently preferred embodiments of the invention, examples of which are illustrated in the accompanying drawings.

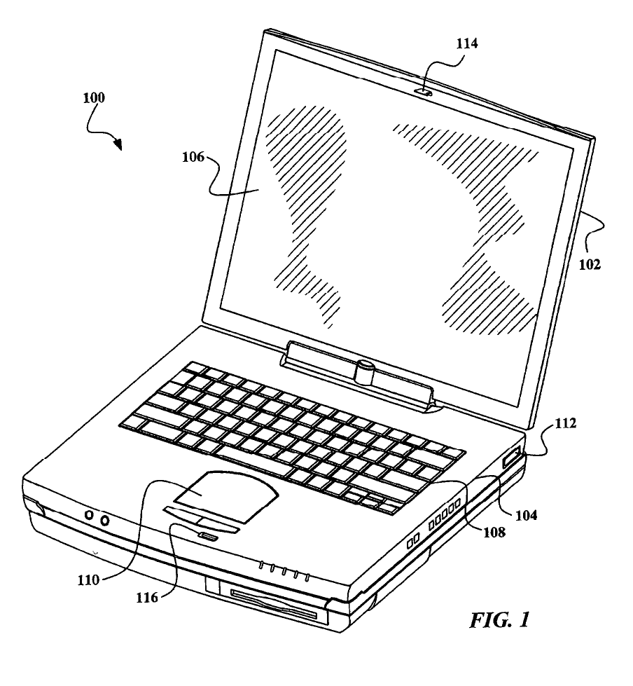

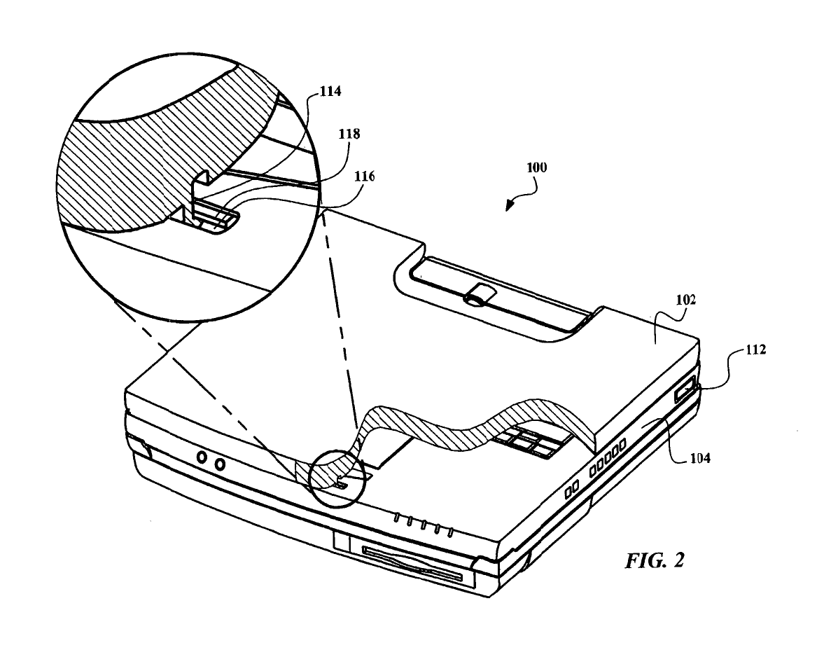

Referring generally now to FIGS. 1 though 8, exemplary embodiments of the present invention are shown. Portable information handling systems, such as internet appliances, digital information appliances, laptop computers, tablet computers, and the like, may be utilized in a wide variety of locations. Indeed, due to their portable nature, portable information handling systems are often configured to obtain different configurations for transport and utilization of the information handling system to protect the information handling system from damage while being transported, such as in a closed orientation, but may then be utilized in an open orientation to enable a user to enter data and interact with the information handling system in an efficient manner.

However, because information handling system may be utilized in a variety of circumstances, the positioning of the functional components may not be as convenient in some situations as in others, and may result in inadvertent implementation of a function of the information handling system. For instance, an external power switch may be positioned to be easily accessible to a user when in an office setting, but may be susceptible to involuntary operation in other settings. Therefore, the present invention provides a system and method for creating a dependency between the orientation of an information handling system and the operation of a power switch. Thus, by utilizing the present invention, inadvertent shut down of the information handling system may be reduced, and even eliminated.

Referring now to FIG. 1, an exemplary embodiment of the present invention is shown wherein a portable information handling system 100 in an open orientation is shown. The information handling system 100 includes a display portion 102 which is rotatable connected to an input portion 104. The display portion 102 includes a display device 106 for outputting data which is viewable by a user of the information handling system 100. The input portion 104 may include input devices, such as a keyboard 108, cursor control device 110, and the like as contemplated by a person of ordinary skill in the art. In this example, when the information handling system 100 is in the open orientation, the input portion 104 and the display portion 102 are positioned so that a user may interact with both the display device 106 of the display portion 102 and the input device, such as a keyboard 108, of the input portion 104.

The information handling system 100 also includes an external power switch 112 which is configured to be manipulated by a user for transitioning the information handling system between power states (e.g., between the power-off state and the power-on state or into a sleep mode or power saving state). The external power switch 112 is depicted in FIG. 1 as being located on the side of information handling system 100. In some embodiments of the invention, however, the external power switch 112 is located on the top surface of information handling system 100, for example, near the keyboard 108 (e.g., between the keyboard 108 and the display device 106). Alternatively, the external power switch 112 may be located on a surface of display portion 102 outside the display device 106, or on any other surface of the information handling system 100 which is readily accessible to a user. Through use of the power switch, the information handling system may be placed in a power-on state in which the information handling system is suitable for interaction with a user (such as by enabling use of the display device 106, keyboard 108, cursor control device 110, and the like), a hibernation state, a stand-by state, a power-off state, and the like. It should be noted by a person of ordinary skill in the art that a wide variety of power-states are contemplated by the present invention without departing from the spirit and scope thereof.

For securing the information handling system in a closed state, a locking member 114 is provided which engages a receptacle 116. For example, referring now to FIG. 2, an exemplary embodiment of the present invention is shown wherein an information handling system 100 as shown in FIG. 1 is positioned in a closed orientation. The locking member 114, which may be configured as a latch or the like, is positioned within the receptacle 116 to secure the display portion 102 to the input portion 104. In this instance, the locking member 114 and receptacle 116 operate as a display closed switch to indicate that the information handling system is in a closed orientation. For example, a contact 118 may be included within the receptacle, which when contacted by the locking member 114, provides an indication that the information handling system is closed. In this instance, while in a closed orientation, the display 106 and at least one input device, such as the keyboard 108 and cursor control device 110, are protected by being disposed between the display portion 102 and input portion 104 of the display device.

As previously mentioned, the portable nature of some information handling systems may result in a positioning of functional components that is not optimal for all encountered situations. For instance, an information handling system may be utilized by a user in an open orientation, such as that shown in FIG. 1, while in a mobile application. However, when the user is in an office situation, the user may desire to use a larger display, full sized keyboard, and the like, such as that provided in a traditional desktop computer. Therefore, the user may connect an external display and keyboard to the information handling system, and position the information handling system in a closed orientation, such as that shown in FIG. 2, so as to conserve resources, protect the components of the information handling system from damage, and the like, yet still operate the information handling system. Thus, a manufacturer of the information handling system may provide an external power switch 112 to enable the power state of the information handling system to be changed while in both the open and closed orientations, as shown in FIG. 1 which depicts the external power switch 112 located on the side of information handling system 100. The manufacturer may alternatively locate the external power switch 112 on the top surface of information handling system 100, for example, near the keyboard 108, intending for the external power switch 112 to be changed only while the information handling system is in the open orientation. However, in conventional systems the power switch may be susceptible to inadvertent operation in certain situations and orientations for either location of the external power switch 112. For example, an external power switch 112 located on the side of information handling system 100 as shown in FIG. 1 may be inadvertently manipulated by the user's finger, catch on the user's clothing, or otherwise be bumped causing an accidental change of power state. The external power switch 112 may also be inadvertently manipulated when it is located on the top surface of information handling system 100 (e.g., near the keyboard 108) and is not exposed when the information handling system is in the closed orientation, that is, when the notebook computer is closed. For example, with a closed notebook computer an accidental change of power state can occur if a user squeezes the display portion 102 against the input portion 104, thus causing the display portion 102 to inadvertently manipulate external power switch 112 even though the information handling system is in the closed orientation and the power switch 112 is not exposed. Through use of the present invention, a dependency may be created between the orientation of the information handling system and the power switch.

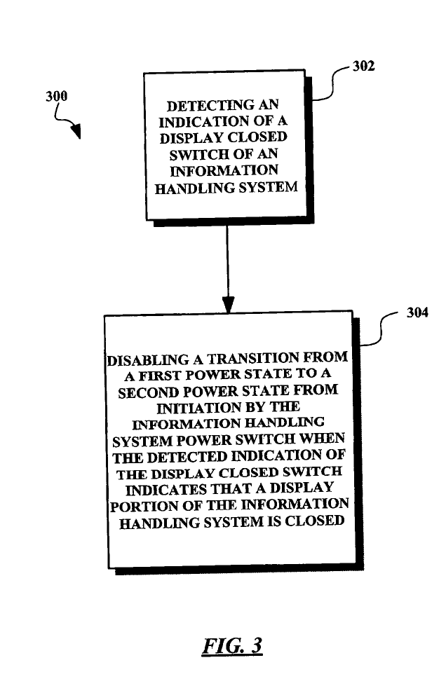

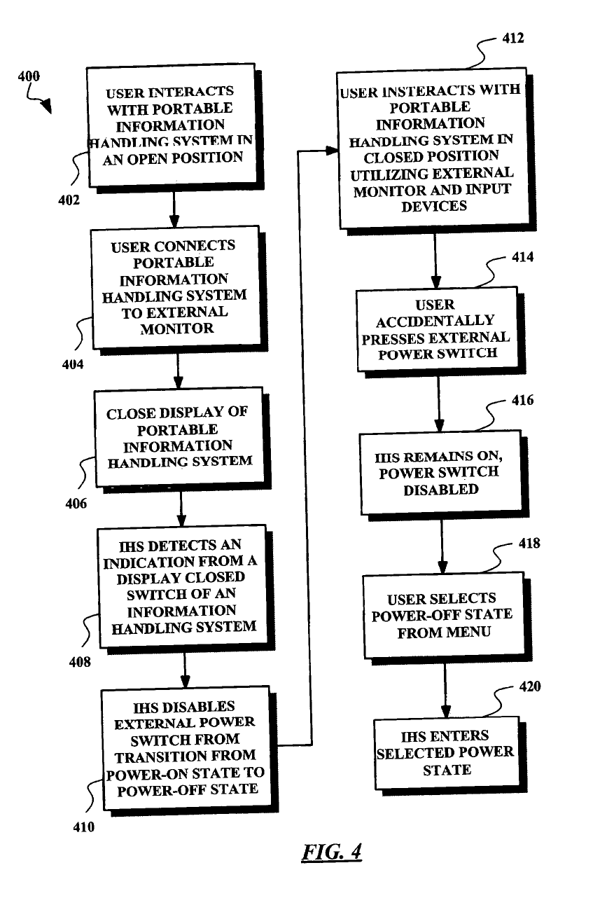

Referring now to FIG. 3, an exemplary method 300 of the present invention is shown wherein a detected indication from a display closed switch of an information handling system is utilized to disable a transition between power states as initiated by an external power switch. An indication of a display closed switch of an information handling system is detected 302. For instance, a locking member 114 may be positioned within a receptacle 116 to indicate that the display portion 102 is secured to an input portion 104 of an information handling system 100 (FIG. 2). A transition from a first power state to a second power state as initiated by an external power switch 112 (FIG. 2) is disabled when the detected indication of the display closed switch indicates that a display portion 102 of the information handling system 100 is closed.

For instance, when the information handling system is transitioned from an open orientation of FIG. 1 to a closed orientation of FIG. 2, the external power switch 112 may be disabled from changing the power state of the information handling system. Thus, if the information handling system was in a power-on state in an open orientation, and then positioned in a closed orientation, the information handling system would be prevented from having the power state changed through use of the external power switch. Likewise, if the information handling system was in a power-off state in an open orientation, and then closed, the information handling system may be prevented from being powered-on by the external power switch. Preferably, the information handling system will still allow other user and automatic power state features to be utilized, such as a selectable power state through use of a menu by a user, automatic power saving features, and the like as contemplated by a person of ordinary skill in the art.

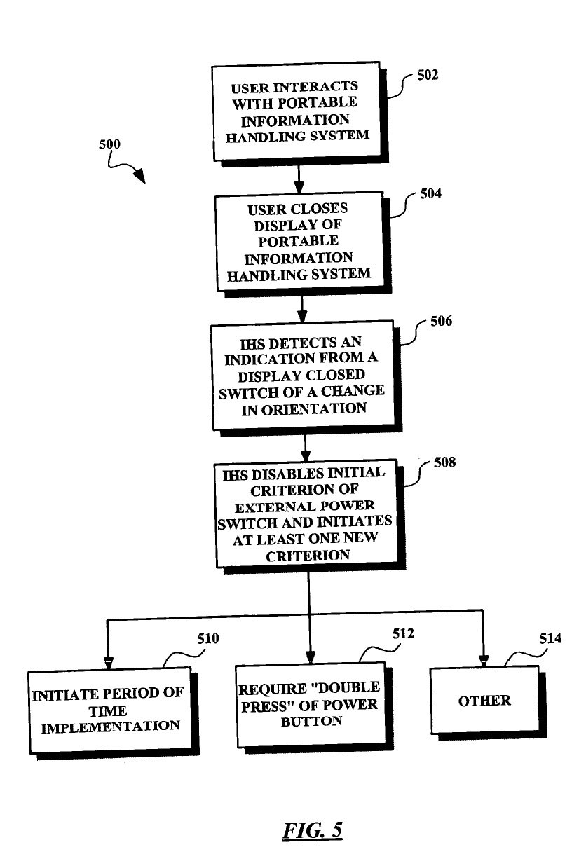

For example referring now to FIG. 4, an exemplary method 400 of the present invention is shown wherein user interaction with an information handling system having multiple configurations is shown. A user interacts with a portable information handling system in an open position 402, such as by utilizing a laptop computer on a work surface. Desiring the use of a larger display device, the user connects the portable information handling system to an external monitor 404. The user then closes the display of the portable information handling system 406 so that the information handling system is in a compact form factor. The information handling system detects an indication from a display closed switch of the information handing system 408 of the positioning of the information handling system in the closed orientation. The information handling system disables an external power switch from being able to transition the information handling system 410, such as from the power-on state to a power-off state.

The user then interacts with the portable information handling system in the closed position through use of the external monitor and input devices 412. Through use of the present invention, if the user accidentally presses the external power switch 414, such as when repositioning the information handling system, the information handling system remain on, because the external-power switch has been disabled 416. If the user desires to power-down the information handling system, the user may select a power-off state from a menu 418 so that the information handling system enterers the selected power state 420. In this way, an information handling system employing the present invention may be prevented from an unintentional change in power states, but still retain the ability to enter a desired power state.

Referring now to FIG. 5, an exemplary method 500 of the present invention is shown wherein a criterion for operation of a power switch of an information handling system is dependent on the orientation of the information handling system. A user interacts with a portable information handling system 502. During interaction, the user may close the information handling system 504 yet still desire to continue interaction with the system. As before, the information handling system detects an indication from a display closed switch of the change in orientation 506. The information handling system disables initial criteria for operation of the external power switch and initiates at least one new criterion 508.

For example, the information handling system may instigate criteria based on the orientation of the information handling system, such as initiating a period of time for implementation 510, require a double manipulation of the external power switch 512, and the like as contemplated by a person of ordinary skill in the art. For instance, when in a closed orientation, an information handling system may require that a user press the external power switch for a longer period of time to initiate a change in power mode than the time required when the information handling system was in an open orientation.

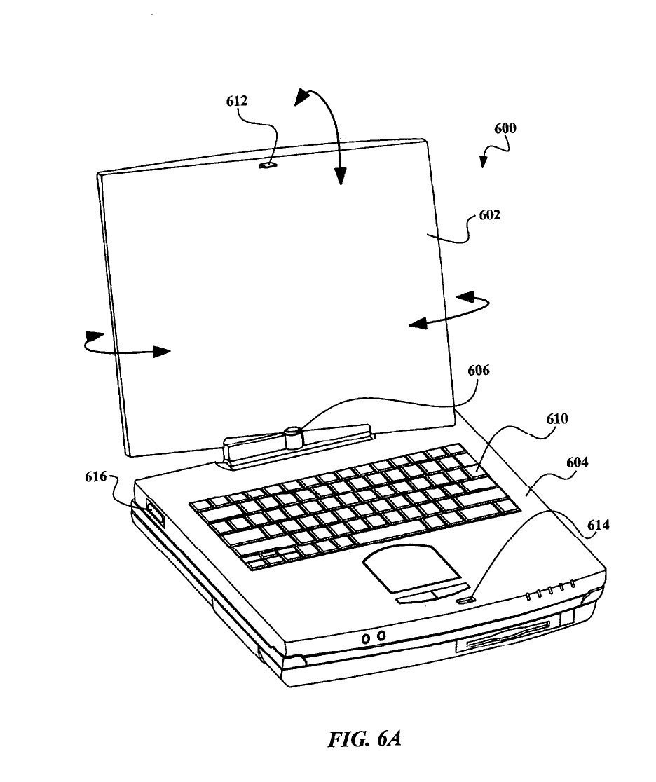

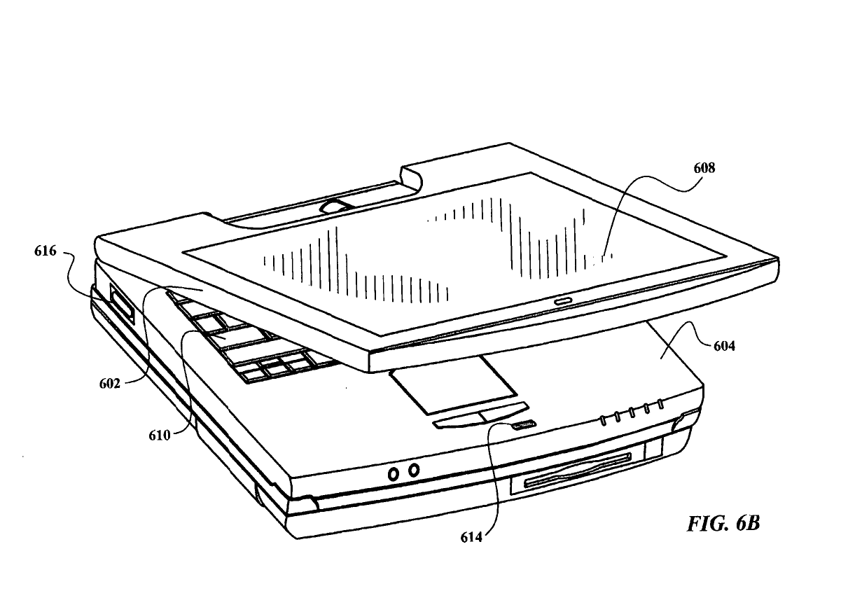

Referring now to FIGS. 6A & 6B, an exemplary embodiment of the present invention is shown wherein an information handling system 600 configurable as a tablet is shown. The information handling system 600 may include a pivot 606 disposed between the display portion 602 and the input portion 604 to enable the input portion 604 to be secured to the display portion yet still have the display 608 viewable by a user. In this way, a user may carry the information handling system 600 and interact with the display 608, such as through use of a touch screen and the like, without requiring the user to utilize the input device 610 of the input portion 604.

To secure the display portion 602 to the input portion, an additional locking mechanism may be employed which is operational as a display closed switch to indicate the orientation of the information handling system 600. The locking mechanism may include a locking member 612 disposed opposite the display device 608 on an opposing side of the display portion 602. Detection of an indication from this additional display closed switch may indicate to the information handling system that the system has been placed in a tablet orientation. In this example, the information handling system is capable of attaining three orientations, an open orientation as shown in FIG. 1, a closed orientation as shown in FIG. 2, and the tablet orientation as shown in FIG. 6B. Because of the availability of a tablet orientation for the present information handling system, it may be desirable to instigate criteria for operation of the external power switch that is particular to this orientation.

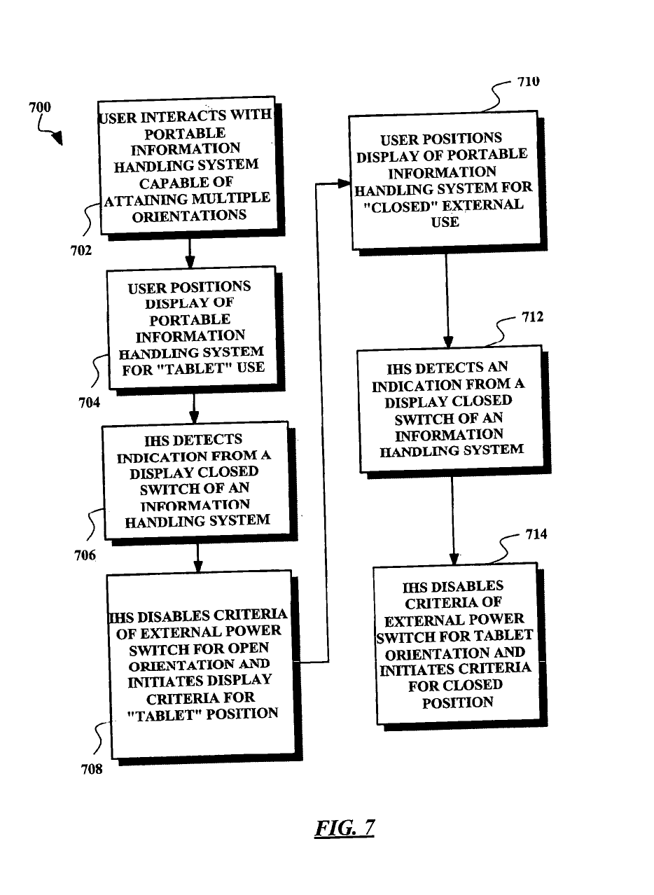

Referring now to FIG. 7, an exemplary method 700 of the present invention is shown wherein user interaction with an information handling system capable of attaining at least three orientations is shown. A user interacts with a portable information handling system capable of attaining multiple orientations 702, such as by entering data into the information handling system in an open orientation. The user positions a display of the portable information handling system for tablet use 704. The information handling system detects an indication from a display closed switch of the information handling system 706. The information handling system disables criteria of the external power switch for an open orientation and initiates display criteria for the tablet position 708.

After using the system in the tablet orientation, the user may then desire that the information handling system be positioned in a closed orientation 710, such as for connection to an external device. The information handling system detects an indication from a display closed switch of the information handling system 712 and disables criteria of the external power switch for the tablet orientation and initiates criteria for a closed position 714. In this way, criteria for the external power switch may be made dependent on the orientation of the information handling system, and different criteria utilized for each orientation. It should be realized by a person of ordinary skill in the art that a wide range of criteria are contemplated by the present invention without departing from the spirit and scope thereof.

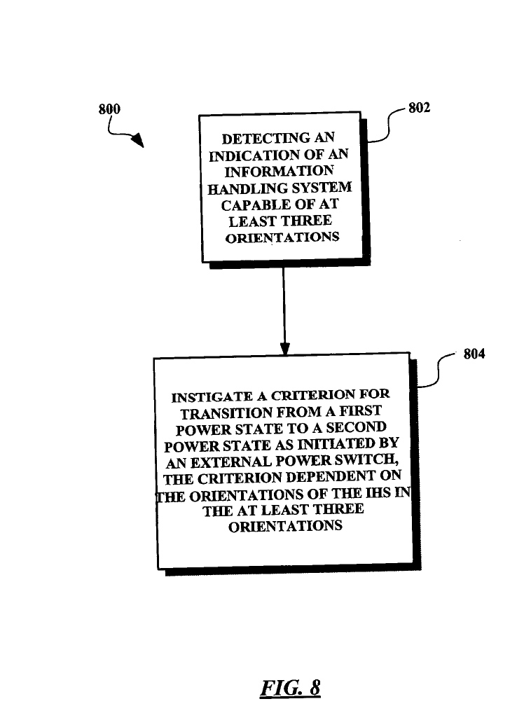

Referring now to FIG. 8, an exemplary method 800 of the present invention is shown wherein criterion are instigated for operation of an external power switch depending on which orientation of at least three orientations an information handling system is configured. An indication of the orientation of an information handling system capable of at least three orientations is detected 802. A criterion for transition from a first power state to a second power state as initiated by an external power switch is instigated. The criterion is dependent of the orientation of the information handling system in the at least three orientations 804. For example, a power switch may require a longer depress time when in a tablet state as opposed to an open state, may require a user to press a power switch twice to initiate a function while in a closed state, and the like as contemplated by a person of ordinary skill in the art.

In exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the system and method of the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

1. A method for controlling utilization of an external power switch of an information handling system, comprising:
detecting an indication from a display closed switch of an information handling system; and
disabling a transition from a first power state to a second power state from initiation by the external power switch of the information handling system when the detected indication of the display closed switch indicates that a display of the information handling system is closed.

2. The method as described in claim 1, wherein the first power state is a power-off state and the second power state is a power-on state.

3. The method as described in claim 1, wherein the display closed switch includes
a locking member disposed on at least one of a display portion of the information handling system and an input portion of the information handling system; and
a receptacle disposed on at least one of a display portion of the information handling system and an input portion of the information handling system;
wherein positioning of the locking member within the receptacle provides in the indication that the display of the information handling system is closed.

4. The method as described in claim 1, wherein the information handling system may obtain at least three orientations, the at least three orientations including a closed orientation, an open orientation and a tablet orientation.

5. The method as described in claim 4, wherein each of the at least three orientations includes a criterion for operation of the external power switch which is different from at least one other criterion of the other two orientations.

6. The method as described in claim 4, wherein the open orientation includes a display disposed on a display portion of the information handling system and an input device disposed on an input portion of the information handling system, the display and input device both orientated toward a user of the information handling system, and wherein the tablet orientation includes the display disposed on a display portion of the information handling system oriented toward the user, the display positioned over the input device of the input portion of the information handling system so that the input device disposed on the input portion for utilization in the open orientation is not operable by a user when in the tablet orientation.

7. The method as described in claim 1, wherein disabling includes disabling an initial criterion of the external power switch and initiating a second criterion for utilization of the external power switch.

8. The method as described in claim 7, wherein the second criterion includes at least one of initiating a period of time for interaction with the external power switch before implementation of function from the external power switch and requiring at least two manipulations of the external power switch for operation of the external power switch.

9. An information handling system, comprising:
a display portion including a display device;
an input portion including an input device for input of data by a user of the information handling system, the input portion rotatable connected to the display portion so that the information handling system is positionable in at least two orientations, the at least two orientations including a closed orientation and an open orientation, the open orientation enabling a user to interact with the input device on the input portion;
a locking member disposed on at least one of a display portion of the information handling system and an input portion of the information handling system; and
a receptacle disposed on at least one of a display portion of the information handling system and an input portion of the information handling system; and
an external power switch manipulable by a user in both the open orientation and the closed orientation of the information handling system;
wherein positioning of the locking member within the receptacle disables at least one criterion for transition from a first power state to a second power state of the information handling system as initiated by the external power switch of the information handling system.

10. The information handling system as described in claim 9, wherein the first power state is a power-off state and the second power state is a power-on state.

11. The information handling system as described in claim 9, wherein the information handling system may obtain at least three orientations, the at least three orientations including a closed orientation, an open orientation and a tablet orientation.

12. The information handling system as described in claim 11, wherein each of the at least three orientations includes a criterion for operation of the external power switch which is different from at least one other criterion of the other two orientations.

13. The information handling system as described in claim 11, wherein the open orientation includes a display disposed on a display portion of the information handling system and an input device disposed on an input portion of the information handling system, the display and input device both orientated toward a user of the information handling system, and wherein the tablet orientation includes the display disposed on a display portion of the information handling system oriented toward the user, the display positioned over the input device of the input portion of the information handling system so that the input device disposed on the input portion for utilization in the open orientation is not operable by a user when in the tablet orientation.

14. The information handling system as described in claim 9, wherein disabling includes disabling an initial criterion of the external power switch and initiating a second criterion for utilization of the external power switch.

15. The information handling system as described in claim 14, wherein the second criterion includes at least one of initiating a period of time for interaction with the external power switch before implementation of function from the external power switch and requiring at least two manipulations of the external power switch for operation of the external power switch.

16. A method for controlling utilization of an external power switch of an information handling system, the information handling system capable of attaining at least three different orientations for utilization by a user, comprising:
detecting an indication from an information handling system of the orientation of the information handling system into one of the at least three orientations, the at least three orientations including an open orientation, a closed orientation and a tablet orientation; and
instigating a criterion for transition from a first power state to a second power state of the information handling system as initiated by the external power switch of the information handling system, wherein the criterion is dependent on which orientation the information handling system is positioned of the at least three orientations.

17. The method as described in claim 16, wherein the first power state is a power-off state and the second power state is a power-on state.

18. The method as described in claim 16, wherein the orientation of the information handling system is detected through use of a display closed switch, the display closed switch including
a locking member disposed on at least one of a display portion of the information handling system and an input portion of the information handling system; and
a receptacle disposed on at least one of a display portion of the information handling system and an input portion of the information handling system;
wherein positioning of the locking member within the receptacle provides in the indication that the display of the information handling system is closed.

19. The method as described in claim 16, wherein each of the at least three orientations includes a criterion for operation of the external power switch which is different from at least one other criterion of the other two orientations.

20. The method as described in claim 16, wherein the open orientation includes a display disposed on a display portion of the information handling system and an input device disposed on an input portion of the information handling system, the display and input device both orientated toward a user of the information handling system, and wherein the tablet orientation includes the display disposed on a display portion of the information handling system oriented toward the user, the display positioned over the input device of the input portion of the information handling system so that the input device disposed on the input portion for utilization in the open orientation is not operable by a user when in the tablet orientation.

21. The method as described in claim 16, wherein the instigated criterion includes at least one of initiating a period of time for interaction with the external power switch before implementation of function from the external power switch and requiring at least two manipulations of the external power switch for operation of the external power switch.
